(19) United States
(12) Patent Application Publication
(10) Pub. No.: US 2014/0001420 A1
(43) Pub. Date: Jan. 2, 2014

(54) Method of preparing metal nanoparticles

(71) Applicants: Lawrence T. Drzal, Okemos, MI (US); In-Hwan Do, East Lansing, MI (US)

(72) Inventors: Lawrence T. Drzal, Okemos, MI (US); In-Hwan Do, East Lansing, MI (US)

(21) Appl. No.: 13/200,764

(22) Filed: Sep. 30, 2011

(51) Int. Cl. H01B 1/02; H01B 1/12; B82B 3/00; B82Y 99/00

(52) U.S. Cl. 252/514; 252/512; 977/896; 977/773

(57) ABSTRACT

A method for the synthesis of new metal based metal nanoparticles by the combination of conducting polymers and room temperature ionic liquids to produce nanoparticle electro-catalysts with very high catalytic activity and controllable size and high surface area to volume ratios.

### BACKGROUND OF THE INVENTION

Fuel cells are key devices to meet the increasing energy needs, energy security, and concerns compatible with a green environment. Low temperature fuel cells such as the proton exchange membrane fuel cell and direct methanol fuel cell have been attracting attention as power sources for home, electric vehicles, and portable devices.

However, noble metal catalysts such as platinum and platinum-base alloys, their high price, and their relatively low catalytic conversion efficiency, are major drawbacks for the success of fuel cells in the marketplace. Success depends on the development of high performance catalysts, for example, platinum, along with methods to help reduce the amount of catalyst used in these applications.

The objective of the instant invention is to synthesize new metal particles in combination with conducting polymers and room temperature ionic liquids to produce nanoparticle electro-catalysts with very high catalytic activity.

There are several prior art methods of producing noble metal nanoparticles. Such methods include platinum nanoparticles stabilized with polyelectrolytes such as poly(diallyldimethylammonium chloride); poly(3,4-ethylenedioxythiophene)-poly(styrenesulfonate); poly(acrylic acid); poly(allylamine-hydrochloride), and with nonionic polymers like poly(vinylpyrrolidone), synthesized via alcohol reduction of a platinum precursor.

However, only poly(diallyldimethylammonium chloride) and poly(sodium 4-styrenesulfonate) showed approximately 20 and 30 percent improvement of catalytic activity for methanol oxidation, respectively, compared with a commercial platinum black material.

Hydroxy-terminated poly(amidoamine) dendrimer-stabilized platinum nanoparticles have been prepared via a traditional NaBH4 reduction in aqueous solution. Poly(amidoamine) platinum catalysts are active for the oxygen reduction reaction but do not show significant advantages over platinum black.

Water soluble polyaniline-coated platinum/ruthenium catalysts were synthesized by conventional NaBH4 reduction combined with freeze-drying. However, the product does not exhibit a high level of catalytic activity for direct methanol fuel cell use.

Undoped polyaniline and poly(sodium 4-styrenesulfonate)-doped polyaniline have been used as a kind of support for platinum nanoparticles. An electrochemical route was adopted to deposit platinum in a spatial layer of polyaniline and polyaniline-poly(sodium-4-styrenesulfonate). Higher catalytic activity in methanol was obtained from the polyaniline/poly(sodium-4-styrenesulfonate), but there is difficulty in controlling the particle size and metal loading.

Platinum nanoparticles were embedded in a conductive polymer, poly(3,4-ethylenedioxythiophene)-poly(styrenesulfonate) film coated on ITO electrode matrices via an electrochemical deposition method. The agglomeration of platinum particles was prevented due to the presence of the poly(3,4-ethylenedioxythiophene)-poly(styrenesulfonate) film. Enhanced catalytic activity of platinum in poly(3,4-ethylenedioxythiophene)-poly(styrenesulfonate) matrix for methanol oxidation was obtained. However, the size of platinum particles was over 100 nm and there were difficulties in controlling the size of metal particles and their loading as in the just above enumerated case.

Ruthenium oxide particles were embedded in poly(3,4-ethylenedioxythiophene)-poly(styrenesulfonate) film coated on ITO matrices via an electrochemical deposition. A maximum specific capacitance of Ruthenium-poly(3,4-ethylenedioxythiophene)-poly(styrenesulfonate) system was 653 F/g. However, there are still difficulties in the control of the size of the ruthenium oxide.

None of these methods are facile to enable the mass production of metal nanoparticles such as, platinum or ruthenium-black and platinum or ruthenium-based alloys which have superior electrocatalytic activity or capacitance compared to a commercial platinum black and ruthenium black that are available in the current market. None of these methods allow adequate control of nanoparticle size.

### THE INVENTION

Thus, what is disclosed and claimed herein is a method of preparing and controlling the particle size of a metal nanoparticle. The method comprises providing a solution containing a predetermined amount of conductive polymer in water and a second solution containing a predetermined amount of a metal particle precursor e.g. metal salt or metal-organic compound in glycol.

The two solutions are mechanically mixed and a predetermined amount of room temperature ionic liquid is introduced to the mixture. Thereafter, the combination from the two solutions is deposited in a microwave and irradiated to reduce the metal precursors to metal nanoparticles having a controlled size.

The advantages of this invention are that it is a simple means to obtain control of the particle size of the nanoparticles through the use of conductive polymers and room temperature ionic liquids. It is easy to scale up for mass production of metal nanoparticles with superior performance. The method is versatile, in that, there are many combinations of metal or metal oxide particles with conductive polymers for numerous applications such as chemical-sensors and biosensors, supercapacitors, batteries, microelectronics, and the like. Metal catalyst precursors useful in this invention can be any metal salt or metal organic compound that is reducible under the conditions of the process of the invention.

Electrocatalysts in fuel cells requiring excellent catalytic activity, and reduction of platinum usage, are the primary markets for this invention. This invention can be applied to the production of electrode materials for sensor and supercapacitors and anode materials for batteries.

### BRIEF DESCRIPTION OF THE DRAWINGS

FIG. 1A is a TEM image of platinum synthesized in the absence of poly(3,4-ethylenedioxythiophene)-poly(styrenesulfonate), sample 1. Scale bar=50 nanometers. (PRIOR ART).

FIG. 1B is a TEM image of platinum synthesized in the presence of 0.07 g of poly(3,4-ethylenedioxythiophene)-poly(styrenesulfonate), sample 2. Scale bar=50 nanometers. (PRIOR ART).

FIG. 1C is a TEM image of platinum synthesized in the presence of 0.15 g of poly(3,4-ethylenedioxythiophene)-poly(styrenesulfonate), sample 3. Scale bar=50 nanometers. (PRIOR ART).

FIG. 1D is a TEM image of platinum synthesized in the presence of 0.30 g of poly(3,4-ethylenedioxythiophene)-poly(styrenesulfonate), sample 4. Scale bar=50 nanometers. (PRIOR ART).

FIG. 1E is a TEM image of platinum synthesized in the presence of 0.45 g of poly(3,4-ethylenedioxythiophene)-poly(styrenesulfonate), sample 5. Scale bar=50 nanometers. (PRIOR ART).

FIG. 2A is a graph of CV results of methanol oxidation activity for platinum/conductive polymer electrocatalysts synthesized in the presence of various concentrations of the conductive polymer. (PRIOR ART).

FIG. 2B is a graph of mass activity of methanol oxidation activity for a platinum/conductive polymer electrocatalyst synthesized in the presence of various concentrations of conductive polymer. (PRIOR ART).

FIG. 3A is a TEM image of platinum/conductive polymer nanoparticles synthesized in the absence of room temperature ionic liquid, sample 6. Scale bar=50 nanometers. (PRIOR ART).

FIG. 3B is a TEM image of platinum/conductive polymer nanoparticles synthesized in the presence of room temperature ionic liquid, sample 7. Scale bar=50 nanometers. (THE INVENTION).

FIG. 4 is a graph of the methanol oxidation activity of platinum/conductive polymer electrocatalysts synthesized-platinum/conductive polymer nanoparticles, synthesized in the absence of room temperature ionic liquid, (PRIOR ART), line (b), and a graph of the methanol oxidation activity of platinum/conductive polymer electrocatalysts synthesized platinum/conductive polymer nanoparticles synthesized in the presence of room temperature ionic liquid, (THE INVENTION), line (c), along with a graph of commercial platinum black, line (a).

FIG. 5A is a TEM image of platinum/conductive polymer nanoparticles synthesized in the presence of 0.05 g polypyrrole with room temperature ionic liquid. Scale bar=50 nanometers. (PRIOR ART).

FIG. 5B is a bar graph associated with the TEM image of FIG. 5A.

FIG. 5C is a TEM image of platinum/conductive polymer nanoparticles synthesized in the presence of 0.1 g of polypyrrole with room temperature ionic liquid. Scale bar=50 nanometers. (THE INVENTION).

FIG. 5D is a bar graph associated with the TEM image of FIG. 5C.

FIG. 6A is a TEM image of ruthenium/conductive polymer nanoparticles synthesized in the presence of 0.05 g of poly(3,4-ethylenedioxythiophene)-poly(styrenesulfonate). (PRIOR ART). Scale bar=50 nanometers.

FIG. 6B is a TEM image of ruthenium/conductive polymer nanoparticles synthesized in the presence of 0.0.1 g of poly(3,4-ethylenedioxythiophene)-poly(styrenesulfonate). (PRIOR ART). Scale bar=50 nanometers.

FIG. 6C is a TEM image of ruthenium/conductive polymer nanoparticles synthesized in the presence of 0.2 g of poly(3,4-ethylenedioxythiophene)-poly(styrenesulfonate). (PRIOR ART). Scale bar=50 nanometers.

FIG. 6D is a TEM image of ruthenium/conductive polymer nanoparticles synthesized in the presence of 0.3 g of poly(3,4-ethylenedioxythiophene)-poly(styrenesulfonate). (PRIOR ART). Scale bar=50 nanometers.

FIG. 6E is a bar graph depicting the images in FIGS. 6A to 6D as a function of the content of the polymer.

FIG. 7 is a bar graph depicting the specific capacitance of ruthenium produced in the absence (sample a), and presence of poly(3,4-ethylenedioxythiophene)-poly(styrenesulfonate) (sample b=0.05 g polymer; sample c=0.1 g polymer; sample d=0.2 g polymer, and sample e=0.3 g polymer).

FIG. 8A is a TEM image of ruthenium/conductive polymer/room temperature ionic liquid nanoparticles. Scale bar=50 nanometers.

FIG. 8B is a cyclic voltammongrams of ruthenium/conductive polymer in 1M H2SO4 at 50 mV/s.

FIG. 9 is a schematic of the synthesis of uncontrolled metal nanoparticles/conductive polymer nano particle.

FIG. 10 is a schematic of the synthesis of size-controlled platinum/conductive polymer nanoparticle of this invention.

### DETAILED DESCRIPTION OF THE INVENTION

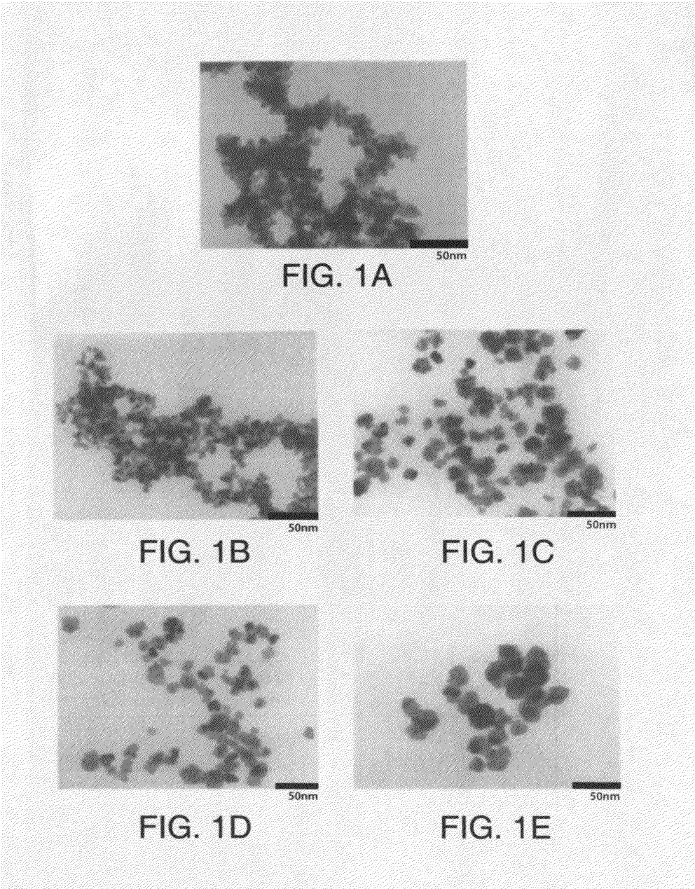

In the prior art, particles reduced by microwave irradiation in ethylene glycol without the addition of a conductive polymer (sample 1) are easily precipitated. It can be observed from FIG. 1A that most of the platinum nanoparticles were agglomerated and connected to form an agglomerated network. The average particle size was about 6 to 7 nm and the size distribution was rather wide. This is due to the lack of a protecting agent which can terminate particle growth of the metal nanoparticles and prevent them from coarsening. Compared with platinum prepared by prior art methods as set forth just Supra, platinum nanoparticles prepared with the addition of 0.07 g. (sample 2) of a conducting polymer, i.e. poly(3,4-ethylenedioxythiophene)-poly(styrenesulfonate), were less agglomerated and slightly smaller in average size as is shown in FIG. 1B (0.07 polymer, sample 3). However, the size of platinum particles increased with an increase of conductive polymer contents shown in FIGS. 1C to 1E (0.15 g, 0.3 g, and 0.45 g, respectively, samples 4, 5, and 6).

It is noteworthy that even though the platinum particles were agglomerated, the platinum agglomerates were composed of only a few large platinum particles and existed separately without forming network morphology.

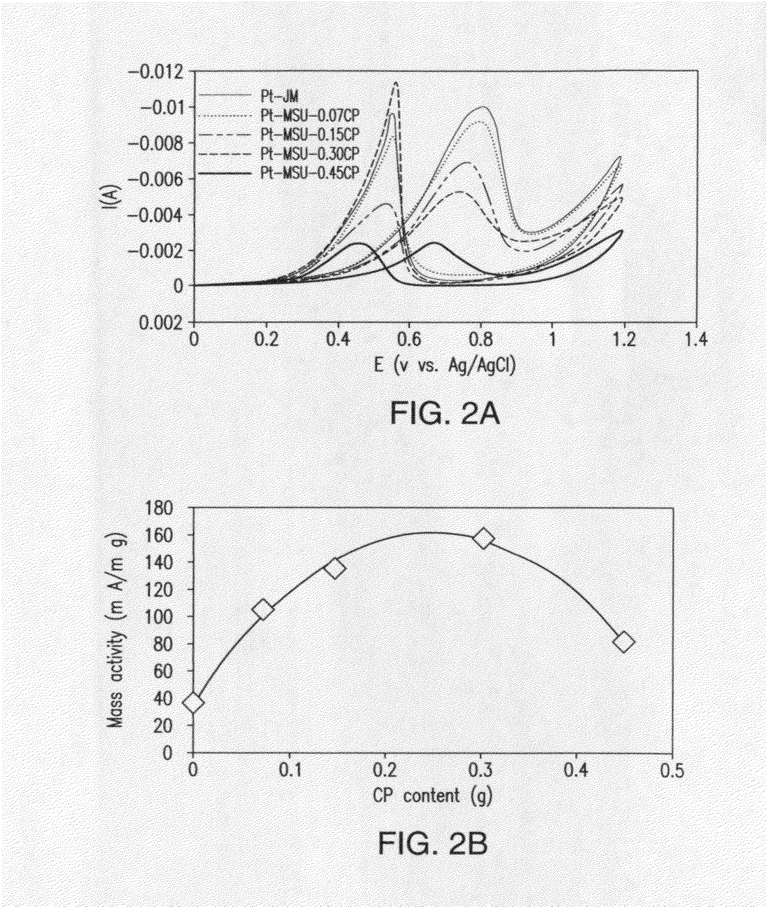

The effect of the conductive polymer content on methanol oxidation activity of samples 1 to 5 is shown in FIGS. 2A and 2B. All of the catalysts show much higher activity than a commercial platinum black. The activity of those catalysts increases with an increase of conductive polymer content up to 0.3 g at which the highest activity is achieved. This result indicates the synergistic effect of the conductive polymers on sample 1 activity because the conductive polymer provides a pathway for both electron and proton transfer at the same time.

However, beyond 0.3 g of conductive polymer, the activity of the platinum/conductive polymer decreases, even if the activity is still higher than that of a commercial platinum black. This results from the formation of large particles, and their agglomeration, and the excess of conductive polymer present on platinum particles as seen in FIG. 1E. Sample 1-based catalysts with at least 5 times better performance than a commercial platinum black can be fabricated at this condition of 0.3 g conductive polymer addition, which is shown in FIG. 2B.

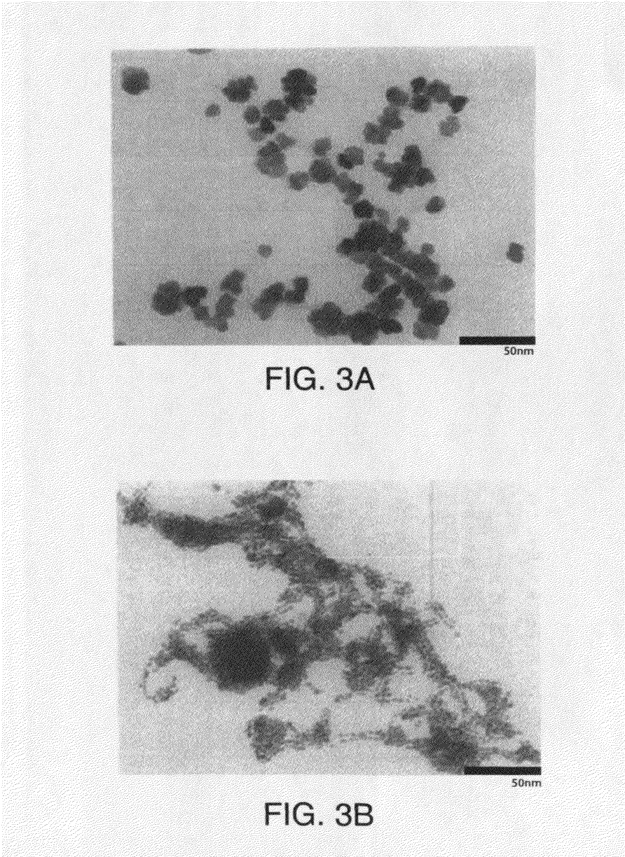

The size and distribution of platinum/conductive polymer nanoparticles can be controlled by the introduction of the room temperature ionic liquid according to this invention, is evident from FIGS. 3A and 3B.

When prepared in the absence of the room temperature ionic liquid, platinum/conductive polymer is about 7 to 9 nm in average size and exists in the form of agglomerates widely ranging from 15 nm to 35 nm in size. However, platinum/-conductive polymer nanoparticles synthesized in the presence of room temperature ionic liquids are clearly separated without agglomeration and have an average size of about 2 to 3 nm, which is beneficial to enhance the catalyst performance due to increased surface area of the active phase and to reduce the amount of catalyst required due to the large surface area to volume ratio of the smaller nanoparticles

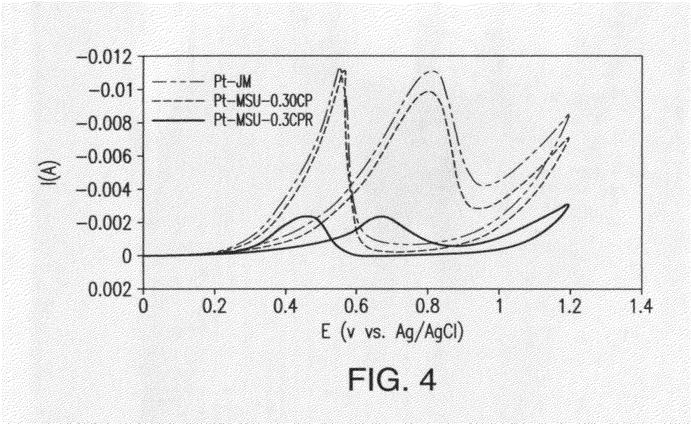

FIG. 4 shows the methanol oxidation activity of platinum/conductive nanoparticles synthesized in the absence and the presence of a room temperature ionic liquid (sample 7, 0.3 g conductive polymer and 0.1 g of room temperature ionic liquid) shows further improved catalytic performance. This results from the absence of agglomeration of the platinum/-conductive polymer nanoparticles as a result of the room temperature ionic liquid addition. It also provides smaller sizes compared to the platinum nanoparticles prepared without room temperature ionic liquid.

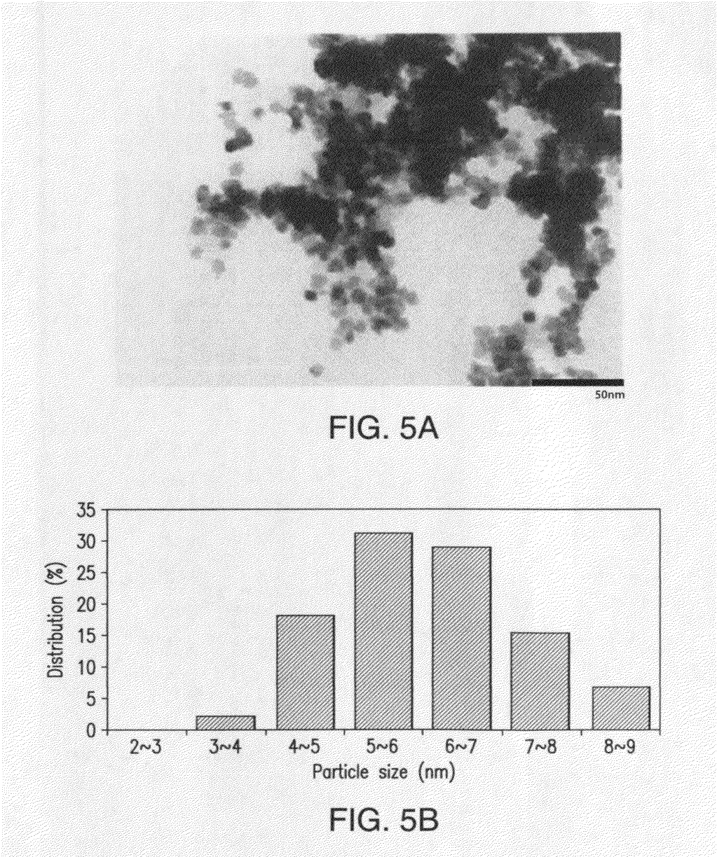

FIG. 5 shows TEM images and size distribution of platinum/-conductive polymer nanoparticles synthesized in the presence of another conducting polymer, polypyrrole. As in the poly(3,4-ethylenedioxythiophene)-poly(styrenesulfonate) system, the average size of the platinum conductive polymer synthesized in the presence of only polypyrrole is 5.91 nm with a wide size distribution and an agglomerated network, while the size of the platinum/-conductive/-polymer room temperature ionic liquid addition is 2.75 nm and is also free from agglomeration.

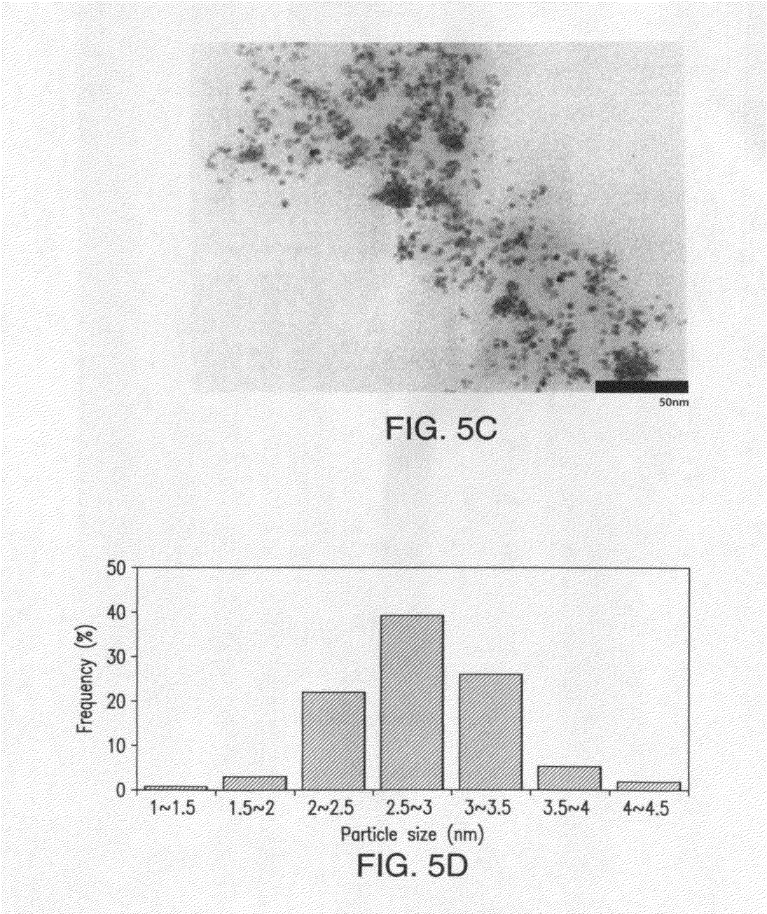

A sample using ruthenium was synthesized under reaction conditions similar to the platinum nanoparticles set forth above. However, the results are different from the platinum case. Ruthenium produced in the presence of the poly(3,4-ethylenedioxy-thiophene)-poly(styrenesulfonate) (PEDOT-PSS) are smaller as the content of the polymer increases (see FIGS. 6A to 6D), while platinum from the similar conditions become larger (see FIG. 1). FIG. 6A is 0.05 g PEDOT-PSS polymer; FIG. 6B is 0.1 g PEDOT-PSS Polymer; FIG. 6C is 0.2 g PEDDOT-PSS polymer and FIG. 6D is 0.3 g polymer. Scale bar for FIG. 6=50 nm. FIG. 6E is the average size of ruthenium conductive polymer nanoparticles synthesized in the presence of poly(3,4-ethylenedioxythiophene)-poly(styrenesulfonate) as a function of the PEDOT-PSS content.

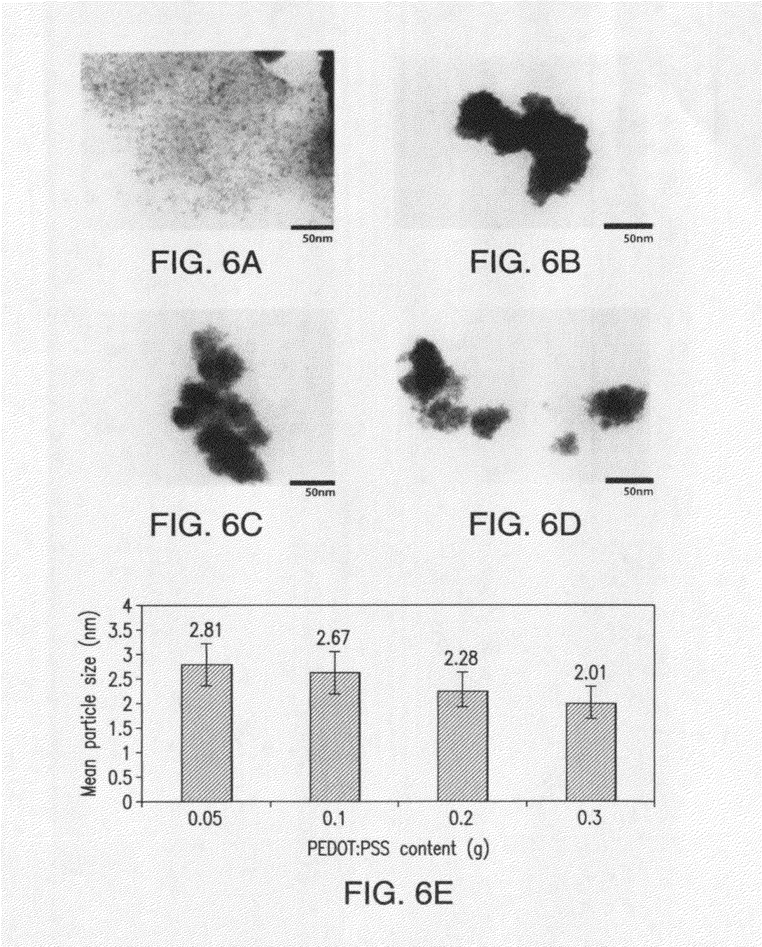

Capacitance of ruthenium produced from the above condition has been studied by cyclic voltammetry. The specific capacitance calculated from data obtained in 1M H₂SO₄ at a scan rate pf 10 mV/s is shown in FIG. 7. The specific capacitance of the ruthenium conductive polymer synthesized in the presence of poly(3,4-ethylenedioxy-thiophene)-poly(styrenesulfonate) is much higher than that of bare ruthenium (denoted as Ru—NR in FIG. 7) which is about 230 F/g.

The specific capacitance of ruthenium 0.1 PEDOT obtained from the addition of 0.1 g of poly(3,4-ethylenedioxy-thiophene)-poly(styrenesulfonate) is 743 F/g. This higher capacitance of ruthenium conductive polymer originates from the incorporation of the polymer stabilizing ruthenium and decreasing the contact resistance of the ruthenium as well as increased amounts of ruthenium particles.

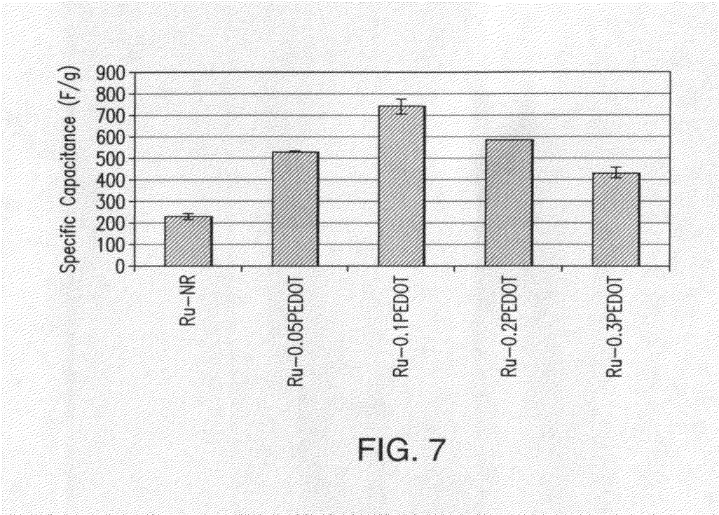

FIG. 8A shows a TEM image of ruthenium conductive polymer synthesized with a room temperature ionic liquid addition. No significant morphological change of ruthenium/conductive polymer nanoparticles with a room temperature ionic liquid, in size and shape is found, which can be compared to that of ruthenium/ conductive polymer without a room temperature ionic liquid (see FIG. 6C). However, as shown in FIG. 8B, the integrated area of a cyclic voltammogram of ruthenium conductive polymer/room temperature ionic liquid nanoparticle sample is larger than that of ruthenium/conductive polymer nanoparticle sample, indicating that high specific capacitance of ruthenium/conductive polymer/room temperature ionic liquid nanoparticle sample over ruthenium/conductive polymer nanoparticle sample. Thus, it is possible to produce ruthenium based electrode materials which can store more charge on their surface by introducing a room temperature ionic liquid and a conductive polymer into the synthesis route.

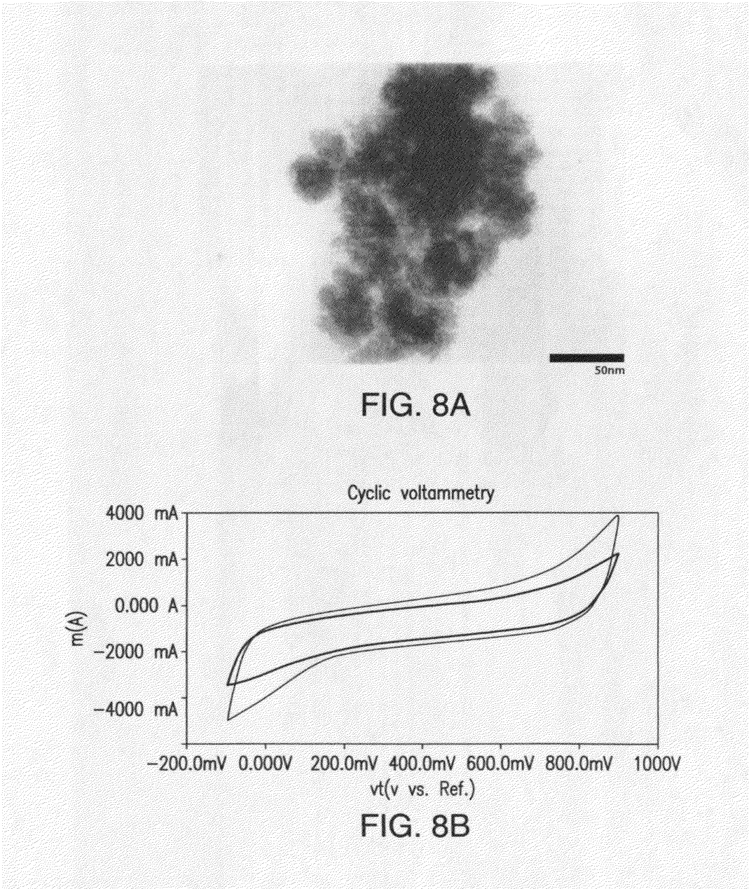

FIG. 9 shows a prior art schematic for uncontrolled nanosized metal conductive polymer nanoparticles synthesis. Platinum nanoparticles are prepared in the presence of a conductive polymer, poly(3,4-ethylenedioxythiophene)-poly(styrenesulfonate). A specific amount of the polymer is dissolved in water and metal precursors in ethylene glycol in a separate beaker. Contents in the two beakers are mechanically mixed, transferred to a microwave oven (2.45 Hz, 1300 W), and finally irradiated under air for a total of 60 seconds to reduce the metal precursors. After cooling down to ambient temperature, the resulting suspension is centrifuged and the residual product is washed with acetone several times and dried in a vacuum oven at 373 K overnight.

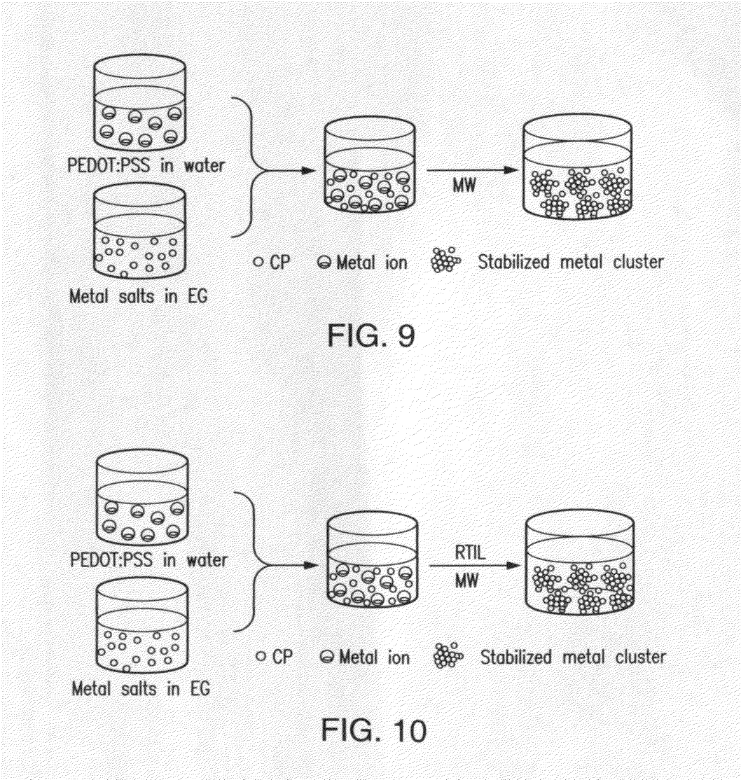

As illustrated in FIG. 10, the process of synthesizing nanosized metal/conductive polymer size-controlled nanoparticles particles in the presence of room temperature ionic liquid differs from prior art methods only in the introduction of room temperature ionic liquid prior to microwave irradiation. The size and morphology of the metal nanoparticles can be controlled by the amount of the room temperature ionic liquid present and the microwave irradiation time.

Metal nanoparticles that can be prepared by this invention consist of, but are not limited to, platinum, ruthenium, palladium, silver, gold, and their alloys.

The nanoparticle materials of this invention have been confirmed as having outstanding performance as compared to a commercial platinum black. Conductive polymers facilitate electron and proton transfer at the same time, which contributes to improved formation of a metal nanoparticle catalyst. Room temperature ionic liquids act as a reaction promoter to increase the chemical reduction rates of the metal salts in the microwave processes, resulting in the formation of smaller and uniform metal particles. Therefore, the combination of conductive polymers and room temperature ionic liquids make it possible to produce agglomeration free, very small nanoparticles in a controlled manner.

What is claimed is:

1. A method of preparing and controlling the particle size of a metal nanoparticle, the method comprising:
A. providing a solution containing a predetermined amount of conductive polymer in water;
B. providing a second solution containing a predetermined amount of a metal particle precursor in glycol;
C. mechanically mixing (A.) and (B.);
D. introducing to the mixture, a predetermined amount of room temperature ionic liquid;
E. depositing the combination from (D.) in a microwave and irradiating the combination to reduce the metal precursors to metal nanoparticles having a controlled size.

2. The method as claimed in claim 1, wherein in addition, the nanoparticles are obtained in a clean and dry form, by:
i. cooling the irradiated combination from (E.) to near room temperature;
ii. centrifuging the cooled material;
iii. decanting the liquid from ii. to provide wet nanoparticles;
iv. washing the wet nanoparticles at least one time with solvent;
v. decanting the solvent and drying in a vacuum.

3. The method as claimed in claim 1 wherein the metal precursor is a metal in the form of a metal salt or metal organic-compound selected from i. metals, ii. metal compounds and, iii. metal alloys, said metal compounds and metal alloys being capable of reduction wherein the metal is selected from groups 4 to 15 of the periodic table of the elements, especially consisting essentially of:
i platinum;
ii ruthenium;
iii palladium
iv silver, and,
v gold.

4. The method as claimed in claim 1 wherein the conductive polymer is selected from the group consisting of:
i poly(3,4-ethylenedioxythiophene)-poly(styrenesulfonate);
ii poly(acrylic acid);
iii poly(allylaminehydrochloride);
iv poly(sodium 4-styrenesulfonate);
v poly(vinylpyrrolidone), and,
vi poly(diallyldimethylammonium chloride).

5. The method as claimed in claim 1 wherein the glycol is selected from consisting essentially of:
i diols, and,
ii polyols.

6. The method as claimed in claim 1 wherein the room temperature ionic liquid is selected from the group consisting essentially of:
i 1-butyl-3-methylimidazolium acetate;
ii 1-butyl-3-methylimidazolium methyl sulfate;
iii 1-butyl-3-methylimidazolium thiocyanate, and
iv 1-butyl-3-methylimidazolium hexafluorophosphate.

7. A metal nanoparticle when prepared by the method of claim 1.
